(19) United States
(12) Patent Application Publication
(10) Pub. No.: US 2006/0065757 A1
(43) Pub. Date: Mar. 30, 2006

(54) Safety Straw TM

(76) Inventor: Daniel C. Calabrese, Clarence Center, NY (US)

Correspondence Address: PATRICIA M. COSTANZO, PATENT COPYRIGHT TRADEMARK LAW, 2960 BOWEN ROAD, ELMA, NY, 14059, US

(21) Appl. No.: 10/949,579

(22) Filed: Sep. 25, 2004

(51) Int. Cl. E03B 9/20; A47G 21/18; A61J 15/00

(52) U.S. Cl. 239/16; 239/33

(57) ABSTRACT

A safety drinking straw having an edge portion of at least one end folded-out and down about a circumference-defined fold-line toward the straw's outer surface and optionally sealed to that surface providing a smooth, rounded end for drinking. If desired, the folded-out portion may be stretched before being folded down toward the outer surface providing a bulbous rim-like portion to provide a wider rounded edge for drinking. The safety straw may be manufactured from paper or plastic by a molding, a spirally wound, or a glued straw stock process. Additional safety straw designs include a doughnut-like extension sealed to at least one straw end; having at least one end closed with an opening on the side of the straw near to the closed end; having a rounded edge on at least one open end; and wherein the edge perimeter of at least one end is capped by a capping portion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

The present invention relates generally to drinking straws and, more particularly, to drinking straws that reduce the unreasonable risks of injury that are now posed to consumers every day in their use of ordinary drinking straws.

The background information discussed below is presented to better illustrate the novelty of the present invention. This background information is not admitted prior art.

The opposing ends of the common drinking straw normally have sharp edges that pose a hazard to users, both young and old. It has been well-documented that straw users, often young children, have injured various body parts with the end of a straw. Hospitals have recorded various degrees of injuries from straws being improperly inserted into noses, ear canals, eyes, and throats. When the material from which the straw is made is rigid, such as when a straw in made of plastic or plastic reinforced paper, the straw has been known to pierce the roof of a user's mouth.

In the past, straws were generally used by young people or when drinks in tall glasses were served, such as an ice cream soda or a milk shake. However, because of the public's ever increasing concern with the presence of germs, restaurants and drinking establishment now routinely provide straws to the public with nearly all drinks that are served. Today it is a rare event to have even a glass of water served without being accompanied by a straw. Therefore, it is well appreciated that the probability of injury from the use of the ubiquitous sharp-edged straw has increased as dramatically as has been the use of drinking straws.

Moreover, drinking straws are now more frequently manufactured from some form of plastic instead of paper as was more common in the past. As plastic is much more rigid than paper, and does not become soft when exposed to liquid, the possibility of injury, especially to children, as well as the severity of injury, caused by misuse of sharp-edged straws has increased.

Thus, it is clear that an alternative to straws having sharp-edges is urgently needed. It is, therefore, clearly appreciated that a straw that decreases the risks posed by the drinking straws in common use today would be greatly appreciated by straw users, the medical profession, and the care-givers of those who are most apt to be injured by straws with sharp edges, as well as by the straw industry itself as the many costs of such injuries would be reduced. Such costs would include both the cost of medical and legal insurance for those who manufacture straws and for those who provide straws for everyday use. Moreover, the occurrence of law suits connected with injuries caused by sharp-edged drinking straws would be expected to decrease.

There have been some attempts at fulfilling this need, but all efforts to date have resulted in devices presenting serious drawbacks. One such attempt provides a drinking straw having a typical tube-like body with openings at each end and a mouthpiece attached to the drinking end tip of the straw main body. The mouth piece is rather large, too large to penetrate skin tissue or to be poked into an ear or nose, for example. The problem is that the mouthpiece is too large to be economical or convenient and would, most likely, be considered as a more costly specialty item.

Another type of straw that has been described is one where the end portion of the body of the straw is deformed inwardly to form a reinforcing inner layer. This procedure, which is done to prevent the straw from collapsing when it become wet, reduces the inner diameter of the straw which restricts the flow of liquid through the straw and, additionally, provides a ledge upon which bits of solid material in a drink to become lodged there causing, perhaps, the straw to become plugged. This teaching also recommends the addition of wax or other type of water proof coating be added to the reinforced portion.

In view of the foregoing, it is clear that what is still lacking in the art is a drinking straw that reduces the possibilities of injuries associated with their use or misuse. Such a straw should be made of readily available and low cost material and be of simple structure and thus, easy to make and having a low manufacturing cost so that the straw would be affordable for all. Moreover, the style of the straw should be streamlined for easy packaging and convenient use.

### SUMMARY

The present invention satisfies the unmet need for a novel drinking straw that reduces the unreasonable risks of injury that are now posed to consumers every day in the use, or misuse, of ordinary drinking straws. Safety drinking straws, according to the principles of the present invention, are made of readily available and low cost material using standard manufacturing techniques, are of simple structure, easy to make, and provide for a low manufacturing cost so that the straw is generally affordable. Moreover, the style of the straw is as streamlined as the straws that are presently available so there is no need for any innovative or expensive packaging. Additionally, the straw made according to the principles of the present invention is just as easy and convenient to use as the drinking straws now commonly available.

The safety drinking straw, as disclosed herein is referred to as Safety-Straw™, and may be made in several different attractive styles. Each Safety-Straw™ style comprises an elongate tube having a range of diameters, where the diameters are small enough for the straw to feel comfortable in the mouths of children and adults and, yet large enough to allow a satisfying amount of liquid to be easily, though safely obtained by using the straw. The lengths of the straws may commonly vary from about three to twelve or more inches, but of course other sizes are also within the scope of the invention. Safety-Straws™ may be made of plastic or, if desired, paper or coated-paper, or any other material that will readily and inexpensively form the straw. Safety-Straws™ may offer one safety end or have both ends adapted for safer use, as desired.

Each of the various designs of your invention greatly reduces the risk of a user's mouth or other body part being perforated or otherwise injured by the straw by providing for drinking straws where the ends of the straws provide minimal or no risk to the user of the straw.

One preferred Safety-Straw™ design disclosed herein provides for a drinking straw where the drinking end portion of the straw presents a smooth, slightly widened, rounded “lip” or “rim” through which the desired liquid reaches the mouth of a user. The rounded lip is produced by folding-out and away from the straw's outer surface the end portion of the straw body so that the folded-out portion is nearly perpendicular to the long axis of the straw. The folded-out portion is then slightly stretched away from the body of the straw radially. The radially-stretched portion of the straw is then pushed down and toward the straw's outer surface. The slight stretching provides for the folded over end to acquire a slightly bulbous-like shape that ensures a maximum width for the rounded portion of the safety-edge. This process is similar to the process of rolling up a shirt sleeve. When a shirt sleeve is rolled up, the edge or end of the sleeve is moved away from what becomes the new end of the sleeve. Moreover, the folded up portion of the sleeve becomes rounded and a bit bulkier in width than the rest of the sleeve producing a somewhat bulbous shape, similar to the above described design. The process is completed by sealing the edge portion of the folded-down portion to the outer surface of the straw body. Sealing ensures that the folded-over portion remains securely folded-over, although if desired the folded over edge could be otherwise treated to have it maintain its folded down position on the straw, such as by being crimped, for example, or alternatively, if the material used to manufacture the straw had the property of shrinking upon heating, the edge of the folded over portion could be heated just enough to have the edge shrink tightly about the straw, providing a seal-less seal. This design produces a straw that, while of nearly identical size and of very similar shape to an ordinary drinking straw, does not pose the risks to users that are posed by ordinary drinking straws. Moreover, by folding the end of the straw to the outside of the straw, the inner diameter of the straw is not reduced and, thus, the amount of liquid obtainable through the straw is not reduced. Another advantage offered by rolling the end of the straw to the outside of the straw is that there is no obstruction on the inside of the straw to catch and lodge bits or pieces of solid that may be in the drink, such as the bits of fruit often found in a fruit containing ice cream sodas or milkshakes. This feature prevents clogging of the straw and also removes a potential area for microbial growth.

Another preferred design provides for a drinking straw where one, or both, end portions of a straw is folded-out and about the adjacent straw body, but without the gentle stretching as described above. The rolled-over end of the straw in this design fits closer to the outer surface of the straw and may, or may not, be sealed to the outer surface of the straw body, as desired. This simple process, alone, removes the sharp edges from the drinking end of the straw and, instead, offers a smooth, curved, contoured end for use.

Yet another design of the present invention offers a drinking straw having the perimeter of the drinking end of the straw covered by a rounded bead, where the bead material may be made of the same, or different, material from which the straw is made. The bead may be set about one or both ends of the straw and may be detachably attached to the straw, by any known, or yet to be known sealing method, such as by heating. The bead, which resembles a small “O-ring”, offers the same safety advantages of the straws discussed above. A novel variation of this design would be to offer beads from which various flavors could be sensed by a user or a bead made of a soft candy that would add flavor and substance to the user's experience. The flavor-emitting bead would be especially appreciated by those dieters who may choose not to drink diet sodas, and thus have been heretofore restricted to drinking plain water.

Another alternative design offers a straw having one or both ends closed by the presence of a flat surface over the opening. Drinking is accomplished by the presence of an opening(s) in the side of the straw near to the end of the straw. In those cases where the straw has both ends closed, there would be openings near both ends of the straw. This straw offers superb safety features in that the blunt, closed end(s) of the straw would present little, if any, risk to straw users. The closed ends may be produced by molding or in a separate capping step.

Yet still another Safety-straw™ design comprises a drinking straw having the walls of its elongated body made thicker than conventional straw walls, where the end edges of these thicker walls are molded to a rounded shape, again presenting the safety features of all the other Safety-straw™ designs. This straw design, as are the others, is especially easy to make and thus, offers a low manufacturing cost, which means that the straws are affordable to the general population.

A different style offers a capped Safety-straw™. In this design, a small boot or cap fits over the edge circumference of one or both ends of a straw so as to cover the sharp edges of the end(s) while leaving the openings free for use. The boot offers the same safety features that are offered by the other designs. The boot or cap portion may be sealed to the straw by any known, or yet to be known, sealing methods.

Accordingly, this invention presents all of these advantages by providing a safety drinking straw, comprising a hollow, elongate, tubular body or member, having a relatively small diameter throughout its length, a circumference, an open first and a second end, and an inner and an outer surface. At least one open end is defined by having its edge portion folded-out and away from a circular fold line defined by the circumference of the straw. The folded-out portion is further folded down and toward the outer surface of the member. The folded-out and down portion may or may not be sealed to the surface, as desired, to provide a curved, rim-like cylindrical portion about at least one end of the straw, said cylindrical portion being concentric with the straw, wherein the curved cylindrical portion provides a smooth, rounded edge for safer insertion into a user's mouth.

Moreover, the safety drinking straw may additionally have its folded-out portion slightly stretched before the folded-out portion is further folded down and in toward the outer surface of the straw body member, thus providing a bulbous-like curved cylindrical rim portion about at least one end of the member, where the portion is concentric with the perimeter of the straw to provide a smooth, rounded edge for safer use. The safety drinking straw may have at least one edge portion of the bulbous-like cylindrical portion sealed to the outer surface of the member.

The safety drinking straw invention, additionally comprises:

a hollow, elongate, tubular member, the member having a relatively small diameter throughout its length, a circumference, an open first end, an open second end, and an outer surface,
wherein each open end is defined by an edge on an edge portion,
wherein at least one edge portion comprises a rounded edge, where the rounded edge comprises a doughnut-like extension of the edge, where the extension may or may not be sealed to the member,
wherein the doughnut-like extension provides a curved cylindrical portion about at least one end of the member, the cylindrical portion being concentric with the member,
wherein the curved cylindrical portion provides a contiguous, smooth, rounded edge for insertion into a user's mouth.

Another innovative safety drinking straw design, comprises:
a hollow, elongate, tubular member, the member having a relatively small diameter throughout its length, the member having a circumference, a closed first end, a second end, and a body comprising an outer surface;
at least one opening within said body positioned near to the closed first end, and if desired having a closed second end and an opening near to the second end,
wherein the at least one closed end with an opening provides a smooth, rounded end for insertion into a user's mouth and wherein the opening provides a means for a liquid to be sipped into a user's mouth.

Yet another safety drinking straw design comprises a hollow, elongate, slightly thickened tubular member, having a relatively small diameter throughout its length, a circumference, an open first end, an open second end, and an outer surface,
wherein at least one open end is defined by a rounded edge on an edge portion,
wherein said rounded edge portion provides a smooth, rounded edge for insertion into a user's mouth.

Yet still another safety drinking straw design, comprises a hollow, elongate, tubular member having a relatively small diameter throughout its length, a circumference, an open first and second end, an inner and an outer surface, wherein each open end is defined by an edge on an edge portion, at least one of the edge portions being capped by a capping portion, wherein the capping portion provides a smooth, rounded edge for insertion into a user's mouth. If desired, the capping portion may be sealed to the outer surface of said member.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended, the invention will now be described, by way of example, with reference to the accompanying drawings, wherein like reference characters indicate like parts throughout the several figures, and in which:

FIG. 1a is a side plan view of a prior art drinking straw.

FIG. 1b is a side plan view of a safety drinking straw of the present invention illustrating a fold line.

FIG. 1c is a side plan view of a safety drinking straw ready for use.

FIG. 1d is a top plan view of the safety drinking straw as shown in FIG. 1b.

FIG. 1e is a partial cut-away side plan view of the safety drinking straw as shown in FIG. 1c.

FIG. 2a is a side plan view of another safety drinking straw design of the present invention.

FIG. 2b is a partial cut-away side plan view of a safety drinking straw of the present invention as shown in FIG. 2a.

FIG. 2c is a top plan view of the safety drinking straw as shown in FIG. 2a.

FIG. 3a is a side plan view of yet another safety drinking straw design.

FIG. 3b is a partial cut-away side plan view of the safety drinking straw as shown in FIG. 3a.

FIG. 3c is a top plan view of the safety drinking straw as shown in FIG. 3a.

FIG. 4a is a side plan view of still yet another safety drinking straw.

FIG. 4b is a partial cut-away side plan view of the safety drinking straw as shown in FIG. 4a.

FIG. 4c is a top plan view of the safety drinking straw as shown in FIG. 4a.

FIG. 5a is a side plan view of an additional safety drinking straw design before the design feature is added to the straw.

FIG. 5b is a side plan view of a safety drinking straw of the present invention with the design feature added.

FIG. 5c is a top plan view of the safety straw as shown in FIG. 5b.

FIG. 5d is a side plan view of the boot of the safety straw.

### A LIST OF THE REFERENCE NUMBERS AND RELATED PARTS OF THE INVENTION

9 an edge of an end
10 safety drinking straw
11 a hollow, elongate, tubular member
12 an open first end
13 an inner surface
14 an outer surface
15 an edge portion
16 circular fold line defined by said circumference of member 11
17 a bulbous rim-like smooth, rounded edge
18 side portion of bulbous rim-like smooth, rounded edge 17
19 air space
20 a seal
22 a “beaded” rounded edge
30 a “closed-ended” safety drinking straw
32 closed drinking end of “closed-ended” safety drinking straw 30
34 an opening through which to drink
36 a fully covered end opening of “closed-ended” safety drinking straw 30
38 smooth interior section of “closed-ended” safety drinking straw 30
40 safety drinking straw with molded rounded drinking edge
42 molded rounded drinking edge
50 a safety drinking straw having a safety boot about the edge of the straw
52 a safety boot

It should be understood that the drawings are not necessarily to scale. In certain instances, details which are not necessary for an understanding of the present invention or which render other details difficult to perceive may have been omitted. It should be understood, of course, that the invention is not limited to the particular designs illustrated herein, but encompasses many designs as are discussed throughout the specification.

### DETAILED DESCRIPTION

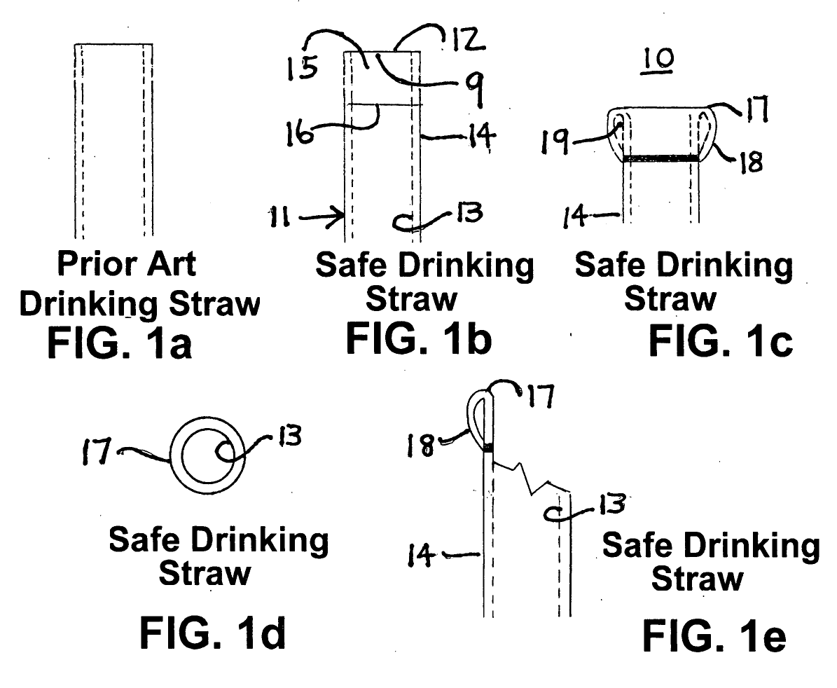

Referring now particularly to the drawings, FIG. 1a presents a side plan view of a common drinking straw. As can be appreciated from FIG. 1a common drinking straws have sharp end edges. These sharp edges are known to cause injuries to users, such as when the sharp end of a straw punctures soft mouth tissue or when the straw is misused, most likely by a small child, where the child pokes the straw into his eye, ear, or nostril. FIGS. 1b-1e present various views of one preferred Safety-Straw ™ design. It is appreciated that the safety drinking straws, as illustrated, are exemplary designs of the present invention and are illustrated to demonstrate how the above mentioned disadvantages have been overcome. It should be noted that the disclosed invention is disposed to designs in many other various sizes, shapes, and forms, such as short Safety-Straws™ for juice sized glasses, averaged sized Safety-Straws™ for typically sized drinking cups and long sized Safety-Straws™ for tall containers such as ice cream soda or milkshake containers. The apertures of the straws may be of any useful diameter and may be specially designed for use with very thick drinks or drinks that contain bits of solid material. Moreover, Safety-Straws™ need not be presented solely as straight straws. They may be made bendable or shaped in any number of ways, especially if the straw is to be used as a means of amusement, as well as for its accepted utility. Therefore, the designs described herein are provided with the understanding that the present disclosures are intended as illustrative and are not intended to limit the invention to the designs described herein.

FIG. 1b, a side plan view, illustrates a basic straw-form from which a safety drinking straw of the present invention is produced. Shown is a hollow, elongate, tubular straw member 11 having an open first end 12, an inner surface 13, an outer surface 14, an edge portion 15 with an edge 9 (note: as the two ends of straws are often identical, the second end of the straw is not shown), and a circular fold line 16 defined by said circumference of straw member 11.

FIG. 1c, a side plan view, shows a drinking end of a safety drinking straw ready for use. This preferred embodiment, is fashioned by folding out and away from outer surface 14 at least one edge portion 9 including a part of inner surface 13. Edge portion 9 is folded-out about a circular fold-line defined by the circumference of the starting straw body illustrated in FIG. 1b. Slightly stretching edge portion 15 as it is folded-out and away from outer surface 14 and before it is folded down toward outer surface 14, results in forming bulbous rim-like portion 17 presenting a smooth, rounded edge for insertion into a user's mouth. The slight stretching of edge portion 15, as it is folded-out and away from edge part 9 of outer surface 14, additionally results in forming air pockets or spaces 19 between the under side of portion 18 of bulbous rim-like smooth, rounded portion 17 and what was outer surface 14 but which surface is now enclosed by side portion 18 of bulbous rim-like smooth, rounded edge portion 17.

FIG. 1d, a top plan view, illustrates the smooth surface of top most part of rounded edge portion 17, which provides for a greatly decreased risk of injury to a user when using a safety drinking straw of the present invention.

FIG. 1e is a partial cut-away side plan view of the safety drinking straw as shown in FIG. 1c to better illustrate the smooth surface of the top most part of rounded edge portion 17.

If desired, the safety drinking straw, as illustrated in FIGS. 1c and 1d, may provide for edge portion of folded-down side portion 18 to be sealed to outer surface 14 of member 11 resulting in seal 19. Seal 19 may be accomplished in any number of ways, including known and yet to be known methods of sealing, such as sealing by heat treatment.

Safety drinking straw 10, may be made by any known straw making means, such as by employing a molding process, a spirally wound process, or a glued straw stock process.

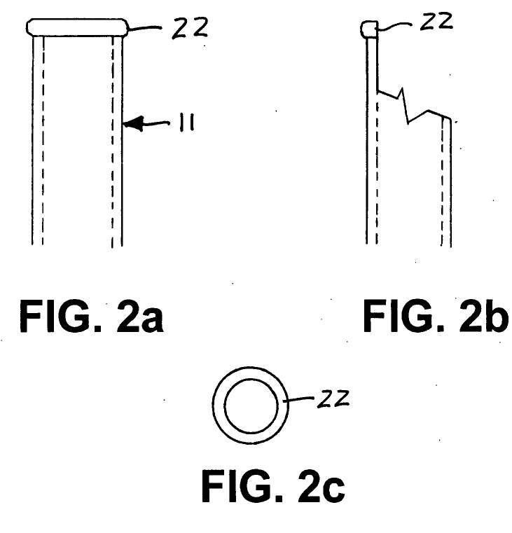

FIG. 2a, a side plan view, illustrates another safety drinking straw design of the present invention where, in order to provide for a smooth, rounded edge for drinking, a bead of material is deposited about what would otherwise be a sharp end edge, such as is encountered in common drinking straws. The beaded rounded edge may be visualized as a doughnut-like extension of the drinking end edge of a straw, wherein the doughnut-like extension provides a cylindrical portion about at least one end of the straw, and wherein the doughnut-like extension is concentric with the straw member, providing a smooth rounded edge for insertion into a user's mouth. Beaded, rounded edge 22 may comprise the material from which straw member 11 is made or some other type of material. If desired, beaded, rounded edge 22 may comprise a candy like substance. Additionally, beaded rounded edge 22 may comprise a flavored material such that the bead material allows the flavor to permeate the bead to be sensed by a user's flavor sensors. This design allows an unflavored drink, such as ordinary tap water, to be enhanced by a multitude of flavors. If, alternatively, the bead were to be made of a candy type material, the bead might be designed to dissolve during the use of the straw or even bitten off of the end of the straw when the user was finished drinking the drink. FIG. 2b, a partial cut-away side plan view, shows another view of an edge-beaded safety drinking straw of the present invention as shown in FIG. 2a. FIG. 2c, a top plan view, illustrates the rounded, safety edge of the safety drinking straw as shown in FIG. 2a.

The beaded safety drinking straw, as shown in FIG. 2a, may be made by any known straw making means, such as by employing a molding process, a spirally wound process, or a glued straw stock process.

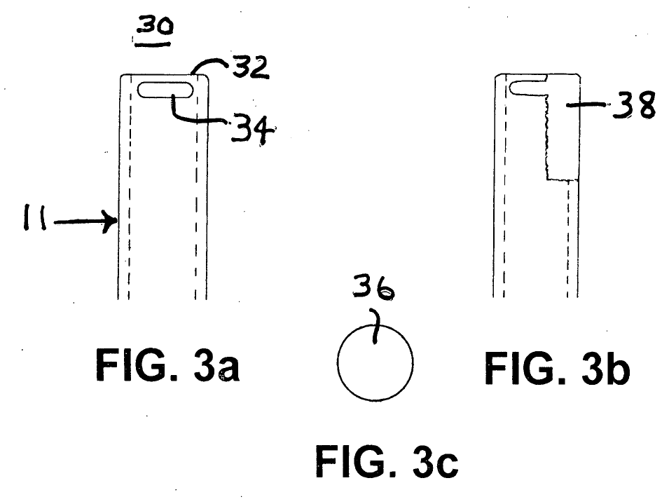

FIG. 3a, a side plan view, illustrates yet another safety drinking straw design wherein at least one opening of a drinking end of a drinking straw is closed. FIG. 3a shows novel “closed-ended” safety drinking straw provided with at least one closed end 32, opening for drinking 34 positioned on said straw member 11 near to at least one closed end 32 providing alternative means for a liquid to be sipped safely into a user's mouth. FIG. 3b, a partial cut-away side plan view of the safety drinking straw as shown in FIG. 3a, provides a view of smooth, unobstructed interior section 38 of “closed-ended” safety drinking straw 30. FIG. 3c is a top plan view showing how the once open end of tubular straw member 11 is, in this design, fully enclosed to provide for closed-ended” safety drinking straw 30. If desired, both ends of Straw member 11 may be fully covered closed, in which case an opening would be provided near to each end 32 to provide means for a liquid to be sipped from its container, through the straw, and into a user's mouth.

Closed-ended safety drinking straw 30, as shown in FIG. 3a, may be made by any known straw making means, such as by employing a molding process, a spirally wound process, or a glued straw stock process.

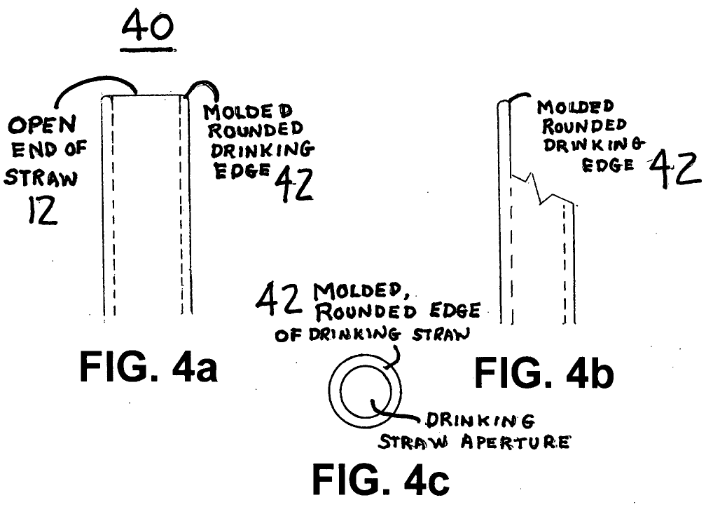

FIG. 4a, a side plan view, illustrates still yet another safety drinking straw design, namely safety drinking straw with molded rounded drinking edge 40. Molded rounded drinking edge 42 is made by increasing the thickness of tube wall thickness of tubular member 11 and by molding the thicker-walled safety straw so that the perimeter area of one or both ends of the straw are molded to a smooth, rounded shape for safe insertion into a user's mouth. FIG. 4b, a partial cut-away side plan, provides a view of the smooth, rounded drinking end of this safety drinking straw design. FIG. 4c is a top plan view of the safety drinking straw as shown in FIG. 4a illustrating the smooth, rounded drinking edge forming a perimeter around the drinking aperture.

The smooth, rounded drinking edge safety drinking straw, as shown in FIG. 4a, may be made by any known straw making means, such as by employing a molding process, a spirally wound process, or a glued straw stock process.

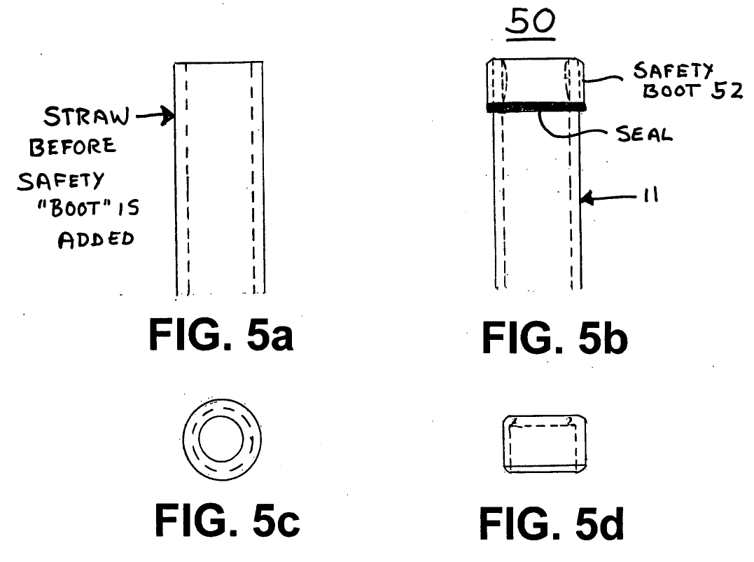

FIG. 5a is a side plan view of a safety drinking straw of an additional design before the design feature is added to the straw. FIG. 5b is a side plan view of a “booted” safety drinking straw 50 having safety boot 52 affixed about the edge of a straw. A safety boot may be thought of as a capping means where the cap fits snugly over the edge perimeter that bounds the drinking aperture of the straw wherein said capping means provides a smooth, rounded edge for insertion into a user's mouth. The safety booth may be made of the same material as the straw or may be made of a complementary material. For example, the straw may be made of a waxed paper, while the boot is made of a heat-treatable material that provides for rapid and easy affixation of the boot to the straw. A boot such as this would provide structural strength and durability to the end or ends of an otherwise more delicate paper straw. Any known, or yet to be known, means of sealing may be utilized, such as heat sealing or using a fixative. FIG. 5c provides a top plan view of the safety straw as shown in FIG. 5b and FIG. 5d is a side plan view of the boot of the safety straw.

The booted safety drinking straw, as shown in FIG. 5b, may be made by any known straw making means, such as by employing a molding process, a spirally wound process, or a glued straw stock process.

The foregoing description, for purposes of explanation, used specific and defined nomenclature to provide a thorough understanding of the invention. However, it will be apparent to one skilled in the art that the specific details are not required in order to practice the invention. Thus, the foregoing descriptions of the specific design of the Safety-straw™ are presented for purposes of illustration and description. They are not intended to be exhaustive or to limit the invention to the precise forms disclosed. Those skilled in the art will recognize that many changes may be made to the features, designs, and methods of making the designs of the invention described herein without departing from the spirit and scope of the invention. Furthermore, the present invention is not limited to the described methods, designs, features or combinations of features but include all the variation, methods, modifications, and combinations of features within the scope of the appended claims. The invention is limited only by the claims.

What is claimed is:

1. A safety drinking straw, comprising:
a hollow, elongate, tubular member, said member having a relatively small diameter throughout its length, a circumference, a first open end, a second open end, and an outer surface,
wherein each open end is defined by an edge of an edge portion,
wherein at least one said edge portion, is folded-out from a circular fold line defined by said circumference of said member,
wherein said folded-out portion is further folded down and toward said outer surface of said member to provide a rim-like cylindrical portion about at least one end of said member,
wherein said cylindrical portion provides for a drinking straw having a smooth, rounded, rimmed end for insertion into a user's mouth.

2. The safety drinking straw, as recited in claim 1, further comprising having said edge portion of said folded-down portion sealed to said outer surface of said member.

3. The safety drinking straw, as recited in claim 1, further comprising stretching said folded-out portion before said folded-out portion is further folded down and toward said outer surface of said member providing for a bulbous rim-like cylindrical portion about at least one end of said member,
wherein said bulbous-like cylindrical portion provides for a drinking straw having a smooth, rounded edge for insertion into a user's mouth.

4. The safety drinking straw, as recited in claim 3, further comprising having said edge portion of said bulbous-like cylindrical portion sealed to said outer surface of said member.

5. The safety drinking straw, as recited in claim 1, further comprising having said safety drinking straw manufactured by a molding process.

6. The safety drinking straw, as recited in claim 1, further comprising having said safety straw made by a spirally wound and glued straw stock process.

7. A safety drinking straw, comprising:
a hollow, elongate, tubular member, said member having a relatively small diameter throughout its length, said member having a circumference, an first open end, a second open end, and an outer surface,
wherein each open end is defined by an edge on an edge portion,
wherein at least one said edge portion comprises a rounded edge,
wherein said rounded edge comprises a doughnut-like extension of said edge,
wherein said doughnut-like extension provides a cylindrical portion about at least one end of said member,
wherein said cylindrical portion provides for a drinking straw having a smooth rounded edge for insertion into a user's mouth.

8. The safety drinking straw, as recited in claim 7, further comprising having said doughnut-like extension sealed to said member.

9. The safety drinking straw, as recited in claim 7, further comprising having said safety straw made by a molding process.

10. The safety drinking straw, as recited in claim 7, further comprising having said safety straw made by a spirally wound and glued straw stock process.

11. A safety drinking straw, comprising:
a hollow, elongate, tubular member, said member having a relatively small diameter throughout its length, said member having a circumference, and two oppositely disposed ends,
wherein at least one end is closed,
a body comprising an outer surface;
at least one opening positioned on said body near to said at least one closed end,
wherein said at least one opening provides a means for a liquid to be sipped into a user's mouth, and
wherein said at least one closed end with said nearby opening provides for a drinking straw having a smooth, rounded end for insertion into a user's mouth.

12. The safety drinking straw, as recited in claim 11, further comprising having at least two closed ends,
at least one opening positioned on said body near to each of said two closed ends
wherein said at least two closed ends each with said nearby opening provides for a drinking straw having a smooth, rounded end for insertion into a user's mouth.

13. The safety drinking straw, as recited in claim 11, further comprising having said safety drinking straw made by a molding process.

14. The safety drinking straw, as recited in claim 11, further comprising having said safety drinking straw made by a spirally wound and glued straw stock process.

15. A safety drinking straw, comprising:
a hollow, elongate, tubular member, said member having a relatively small diameter throughout its length, said member having a circumference, a first open end, a second open end, and an outer surface,
wherein at least one open end is defined by a rounded edge on an edge portion,
wherein said rounded edge portion provides for a drinking straw having a smooth, rounded edge for insertion into a user's mouth.

16. The safety drinking straw, as recited in claim 15, further comprising having said safety straw made by a molding process.

17. The safety drinking straw, as recited in claim 15, further comprising having said safety straw made by a spirally wound and glued straw stock process.

18. A safety drinking straw, comprising:
a hollow, elongate, tubular member, said member having a relatively small diameter throughout its length, said member having a circumference, a first open end, a second open end, and an outer surface,
wherein each open end is defined by an edge on an edge portion,
wherein at least one said edge on an edge portion is capped by a capping portion,
wherein said capping portion provides for a drinking straw having a smooth, rounded edge for insertion into a user's mouth.

19. The safety drinking straw, as recited in claim 18, further comprising having said capping portion sealed to said outer surface of said member.

20. The safety drinking straw, as recited in claim 18, further comprising having said safety straw made by a molding process.
